(19) United States
(12) Patent Application Publication
(10) Pub. No.: US 2010/0020049 A1
(43) Pub. Date: Jan. 28, 2010

(54) PLASMA DISPLAY PANEL

(76) Inventors: Sang-Hoon Yim, Suwon-si (KR); Hak-Cheol Yang, Suwon-si (KR)

Correspondence Address: CHRISTIE, PARKER & HALE, LLP, PO BOX 7068, PASADENA, CA, 91109-7068, US

(21) Appl. No.: 12/506,134

(22) Filed: Jul. 20, 2009

(30) Foreign Application Priority Data
Jul. 24, 2008 (KR) 10-2008-0072430

(51) Int. Cl. G09G 5/00; H01J 17/49

(52) U.S. Cl. 345/204; 313/584

(57) ABSTRACT

A plasma display panel with improved driving timings and reduced number of scan lines. The plasma display panel includes: a first substrate and a second substrate; red (R), green (G) and blue (B) discharge cells between the first substrate and the second substrate at crossing regions of sustain electrodes and address electrodes between the first substrate and the second substrate. A G discharge cell form a pixel with an adjacent one B discharge cell or an adjacent R discharge cell in the first direction, and the G discharge cell and an adjacent G discharge cell in the second direction are offset from each other in the first direction by ½ of a discharge cell pitch of the plasma display panel.

### CROSS-REFERENCE TO RELATED PATENT APPLICATION

This application claims priority to and the benefit of Korean Patent Application No. 10-2008-0072430, filed on Jul. 24, 2008, in the Korean Intellectual Property Office, the disclosure of which is incorporated herein in its entirety by reference.

### BACKGROUND OF THE INVENTION

1. Field of the Invention

The present invention relates to a plasma display panel.

2. Description of the Related Art

A plasma display panel displays images by applying a discharge voltage to discharge cells, which are filled with a discharge gas and sealed between two substrates in which a plurality of electrodes are formed, to generate gas discharges that produce ultraviolet rays to excite phosphor layers in the discharge cells to emit light. The plasma display panel has been regarded as a replacement for conventional cathode ray tube (CRT) display devices.

An exemplary plasma display panel displays a motion picture in sixty image frames per second. A single image frame is presented in 256 gradation gray levels. A single image frame is temporally divided into eight subfields that include first through eighth subfields. Images of the eight subfields are combined to present an image. A reset discharge, an address discharge, and a sustain discharge sequentially occur during each subfield.

The reset discharge removes wall charges that have previously accumulated in each discharge cell so that charge particles of all discharge cells have the same status. After the reset discharge occurs, the address discharge occurs in order to select discharge cells for displaying an image. The address discharge occurs in each row of the discharge cells sequentially from a first row of discharge cells of the plasma display panel to an n^{th} row of discharge cells of the plasma display panel so that suitable wall charges accumulate inside the discharge cells for displaying an image. The address discharge leads to the accumulation of suitable wall charges inside the selected discharge cells, thereby selecting the discharge cells in which the sustain discharge occurs. Ultraviolet rays are generated in the discharge cells in which the sustain discharge occurs, and the ultraviolet rays excite a phosphor substance of the phosphor layers, and thus an image is displayed.

FIG. 1 is a schematic drawing illustrating a plan view of a layout of sustain and address electrodes and discharge cells of a conventional plasma display panel. Referring to FIG. 1, R discharge cells, G discharge cells, and B discharge cells form a single pixel P. The sustain electrodes include X electrodes (e.g., X1 and X2) and Y electrodes (e.g., Y1 and Y2) that are parallel to each other. The address electrodes A1, A2 and A3 are disposed across the sustain electrodes X and Y in each of the discharge cells. Although only partially shown, a full high definition (FHD) high resolution plasma display panel having 1920×1080 pixels includes 1920×3 address electrodes and 1080 Y electrodes (or scan electrodes). In the plasma display panel of FIG. 1, scan signals that are applied to the Y electrodes Y1 and Y2 during an address discharge are sequentially applied to each row of the discharge cells. In more detail, the entire 1080 scan signals are sequentially applied from a first row of the discharge cells to a 1080^{th} row of the discharge cells so as to generate the address discharge in all the discharge cells once.

However, when the plasma display panel has a higher resolution, the number of the discharge cells, the Y electrodes, and the address electrodes increases so that the number of scan signals applied to the Y electrodes increases. For example, when an ultra high resolution plasma display panel having 4096×2160 pixels includes 4096×3 address electrodes and 2160 Y electrodes, since the entire 2160 scan signals need to be sequentially applied to the Y electrodes so as to generate one address discharge in all the discharge cells, the total scan time is increased, thereby reducing the time for applying scan signals corresponding to the rows of the discharge cells. In more detail, when the resolution of the plasma display panel becomes higher, it is difficult to provide a sufficient time to apply scan signals to the Y electrodes.

### SUMMARY OF THE INVENTION

Embodiments of the present invention provide a plasma display panel with sufficient time for applying scan signals to each of its scan electrodes and a plasma display panel having a high resolution or an ultra high resolution with reduced number of scan lines.

According to an embodiment of the present invention, a plasma display panel includes: a first substrate and a second substrate facing the first substrate; barrier ribs between the first substrate and the second substrate for partitioning a space between the first substrate and the second substrate into red (R) discharge cells, green (G) discharge cells, and blue (B) discharge cells; a plurality of sustain electrodes extending in a first direction between the first substrate and the second substrate; and a plurality of address electrodes extending in a second direction between the first substrate and the second substrate, the plurality of address electrodes crossing the plurality of sustain electrodes. A G discharge cell of the G discharge cells forms a pixel with an adjacent one of the B discharge cells or an adjacent one of the R discharge cells in the first direction, and the G discharge cell and an adjacent one of the G discharge cells in the second direction are offset from each other in the first direction by ½ of a discharge cell pitch of the plasma display panel.

A ratio of the total number of the R discharge cells, the G discharge cells and the B discharge cells of a display area of the plasma display panel may be approximately 1:2:1.

Each of the R discharge cells, the G discharge cells and the B discharge cells defined by the barrier ribs may have a substantially rectangular shape.

The plurality of sustain electrodes may include X electrodes and Y electrodes that are parallel to each other in each of the R discharge cells, the G discharge cells and the B discharge cells.

The X electrodes and the Y electrodes may be arranged in an order of X1, Y1, Y2, X2, X3, Y3, Y4, X4 through Xn-3, Yn-3, Yn-2, Xn-2, Xn-1, Yn-1 and Yn, Xn in the second direction.

The X electrodes and the Y electrodes may be arranged in an order of X1, Y1, X2, Y2, X3, Y3, X4, Y4 through Xn-3, Yn-3, Xn-2, Yn-2, Xn-1, Yn-1 and Xn, Yn in the second direction.

Two of the Y electrodes corresponding to two adjacent discharge cells, respectively, in the second direction among the R discharge cells, the G discharge cells and the B discharge cells may be electrically coupled to each other, and the two of the Y electrodes may be configured to be concurrently applied with a scan signal.

Two of the Y electrodes corresponding to two adjacent discharge cells of the R discharge cells, the G discharge cells and the B discharge cells in the second direction may be configured to be concurrently applied with a scan signal.

The plurality of sustain electrodes may include X electrodes, each of the X electrodes corresponding to a row of the R discharge cells, the G discharge cells and the B discharge cells, the row extending in the first direction, and the plurality of sustain electrodes may include Y electrodes, each of the Y electrodes corresponding to two adjacent rows of the R discharge cells, the G discharge cells and the B discharge cells, the two adjacent rows extending in the first direction.

A row of the R discharge cells, the G discharge cells and the B discharge cells extending in the first direction may be disposed in an order of B, G, R and G, and an adjacent row of the R discharge cells, the G discharge cells and the B discharge cells may be disposed in an order of R, G, B and G.

A row of first discharge cells of the R discharge cells, the G discharge cells and the B discharge cells extending in the first direction may have the first discharge cells arranged in an order of B, G, R and G, and an adjacent row of second discharge cells of the R discharge cells, the G discharge cells and the B discharge cells may have the second discharge cells arranged in an order of B, G, R and G.

The plurality of address electrodes may include upper address electrodes and lower address electrodes, and the upper address electrodes and the lower address electrodes may be configured to be addressed by an upper address electrode driving driver and a lower address electrode driving driver, respectively.

The Y electrodes may include upper Y electrodes and lower Y electrodes, and one of the upper Y electrodes and a corresponding one of the lower Y electrodes may be electrically coupled together and applied with a same scan signal.

According to another embodiment of the present invention, a plasma display device includes: a first substrate and a second substrate facing the first substrate; scan electrodes and sustain electrodes extending in a first direction between the first substrate and the second substrate; address electrodes extending in a second direction between the first substrate and the second substrate, the address electrodes crossing the sustain electrodes and the scan electrodes; barrier ribs between the first substrate and the second substrate and defining red (R) discharge cells, green (G) discharge cells and blue (B) discharge cells at crossing regions of the scan electrodes, the sustain electrodes and the address electrodes; an address electrode driving driver for driving the address electrodes; a scan electrode driving driver for driving the scan electrodes; and a sustain electrode driver for driving the sustain electrodes. A G discharge cell of the G discharge cells forms a pixel with an adjacent one of the B discharge cells or an adjacent one of the R discharge cells in the first direction, and the G discharge cell and an adjacent one of the G discharge cells in the second direction are offset from each other in the first direction by ½ of a discharge cell pitch of the plasma display device.

Two of the scan electrodes corresponding to two adjacent discharge cells in the second direction, respectively, among the R discharge cells, the G discharge cells and the B discharge cells may be configured to be concurrently applied with a same scan signal.

Each of the sustain electrodes may correspond to a row of the R discharge cells, the G discharge cells and the B discharge cells, the row extending the in the first direction, and each of the scan electrodes may correspond to two adjacent rows of the R discharge cells, the G discharge cells and the B discharge cells, the two adjacent rows extending in the first direction.

A row of first discharge cells of the R discharge cells, the G discharge cells and the B discharge cells extending in the first direction may have the first discharge cells arranged in an order of B, G, R and G, and an adjacent row of second discharge cells of the R discharge cells, the G discharge cells and the B discharge cells may have the second discharge cells arranged in an order of R, G, B and G.

A row of first discharge cells of the R discharge cells, the G discharge cells and the B discharge cells extending in the first direction may have the first discharge cells arranged in an order of B, G, R and G, and an adjacent row of second discharge cells of the R discharge cells, the G discharge cells and the B discharge cells may have the second discharge cells arranged in an order of B, G, R and G.

The address electrodes may include upper address electrodes and lower address electrodes. The upper address electrodes may be configured to be addressed the address electrode driving driver or a second address electrode driving driver, and the lower address electrodes may be configured to be addressed by the other one of the address electrode driving driver and the second address electrode driving driver.

### BRIEF DESCRIPTION OF THE DRAWINGS

The above and other features and aspects of the present invention will become more apparent by describing in detail exemplary embodiments thereof with reference to the attached drawings in which:

FIG. 1 is a schematic drawing illustrating a plan view of a layout of sustain and address electrodes and discharge cells of a conventional plasma display panel;

FIG. 2 is a schematic drawing illustrating a plan view of a layout of sustain and address electrodes and discharge cells of a plasma display panel according to an embodiment of the present invention;

FIG. 3 is a schematic drawing illustrating a plan view of a plasma display panel for explaining a method of driving electrodes of the plasma display panel of FIG. 2, according to an embodiment of the present invention;

FIG. 4 is a schematic drawing illustrating a plan view of a layout of sustain and address electrodes and discharge cells of a plasma display panel according to another embodiment of the present invention;

FIG. 5 is a schematic drawing illustrating a plan view of a layout of sustain and address electrodes and discharge cells of a plasma display panel according to another embodiment of the present invention;

FIG. 6 is a schematic drawing illustrating a plan view of a layout of sustain and address electrodes and discharge cells of a plasma display panel according to another embodiment of the present invention;

FIG. 7 is a schematic drawing illustrating a plan view of a plasma display panel for explaining a method of driving electrodes of the plasma display panel according to another embodiment of the present invention; and

FIG. 8 is a schematic drawing illustrating a plan view of a plasma display panel for explaining a method of driving electrodes of the plasma display panel according to another embodiment of the present invention.

### DETAILED DESCRIPTION OF EXEMPLARY EMBODIMENTS

An alternating current (AC) 3-electrode surface discharge type plasma display panel according to the present invention will now be described more fully with reference to the accompanying drawings in which exemplary embodiments of the invention are shown. The AC 3-electrode surface discharge type plasma display panel includes a front panel and a rear panel. The front panel includes a front substrate, a plurality of sustain electrodes, a front dielectric layer, and a protection layer. The rear panel includes a rear substrate, a plurality of address electrodes, a rear dielectric layer, barrier ribs and phosphor layers. The front and rear substrates may be first and second substrates, respectively, according to an embodiment of the present invention. The front dielectric layer and the rear dielectric layer may be a first dielectric layer and a second dielectric layer, respectively, according to an embodiment of the present invention. The first and second substrates are spaced apart from each other and face each other. The sustain electrodes are formed on a side of the first substrate facing the second substrate. Pairs of the sustain electrodes extend across the first substrate. The first dielectric layer is coated on the side of the first substrate so as to bury (or cover) the sustain electrodes. The protection layer is formed on the first dielectric layer. The address electrodes formed on a side of the second substrate facing the first substrate extend across the second substrate and cross the sustain electrodes. The second dielectric layer is coated on the side of the second substrate so as to bury the address electrodes. The barrier ribs are formed between the first and second substrates and define a plurality of discharge cells. The barrier ribs may be in rectangular, double-rectangular or stripe shapes. The phosphor layers are coated on surfaces inside the discharge cells.

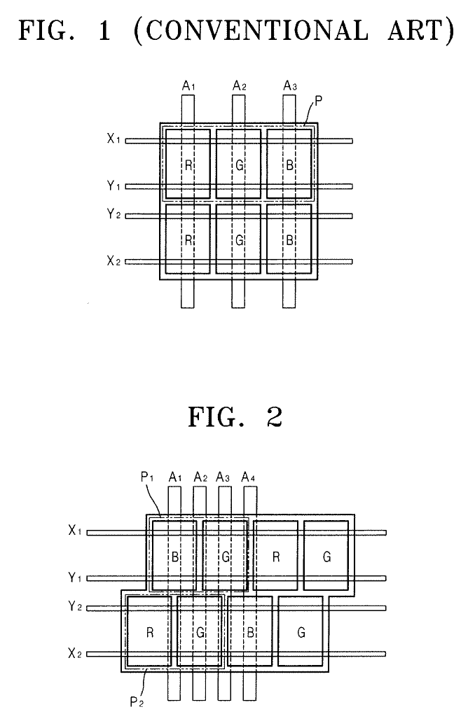

A layout of discharge cells and electrodes of a plasma display panel according to an embodiment of the present invention will now be described in detail with reference to the accompanying drawings. FIG. 2 is a schematic drawing illustrating a plan view of a layout of sustain electrodes, address electrodes, and discharge cells of a plasma display panel according to an embodiment of the present invention.

A display area includes red (R), green (G) and blue (B) discharge cells. In order to implement a high resolution plasma display panel according to an embodiment of the present embodiment, a pixel (e.g., pixel P1 or P2) is formed from two discharge cells, which is different from a pixel formed from three discharge cells.

Furthermore, the G discharge cells, which contribute the most among the R, B and G discharge cells to location information of the pixels, contribute the most among the R, B and G discharge cells to determining the resolution of the plasma display panel. Therefore, the G and B discharge cells are paired together to form a single pixel, or the G and R discharge cells are paired together to from a single pixel. A ratio of the total number of the R, G and B discharge cells of the display area of the plasma display panel is approximately 1:2:1 according to an embodiment of the present invention, but the present invention is not limited thereto. In more detail, the R, G and B discharge cells are disposed in the order of B, G, R, G, B, G, R, G and so on, in a first direction in which X electrodes extend. The pixel P2 including the R and G discharge cells is disposed adjacent to the pixel P1 including the B and G discharge cells in a second direction that crosses the first direction. The G discharge cells of the pixels P1 and P2 are offset from each other by ½ of a discharge cell pitch in the first direction. In the embodiment shown in FIG. 2, the sustain electrodes of the discharge cells include X electrodes (e.g., X1 and X2) and Y electrodes (e.g., Y1 and Y2). In more detail, the sustain electrodes are disposed in the order of X1, Y1, Y2 and X2 in the second direction. The address electrodes A1, A2, A3 and A4 are disposed to cross the sustain electrodes X1, X2, Y1 and Y2. In more detail, the address electrode A1 is disposed to correspond to the B discharge cell of a first row, the address electrode A2 is disposed to correspond to the G discharge cell of a second row, the address electrode A3 is disposed to correspond to the G discharge cell of the first row and the address electrode A4 is disposed to correspond to the B discharge cell of the second row. The R, G and B discharge cells are offset from corresponding R, G and B discharge cells of an adjacent row by ½ of the discharge cell pitch in the first direction, making it possible to insert an additional address electrode, and thus the same scan signals are applied to the Y electrodes Y1 and Y2 of the discharge cells that are adjacent in the second direction. Therefore, the number of scan lines to which scan signals are applied can be reduced by half.

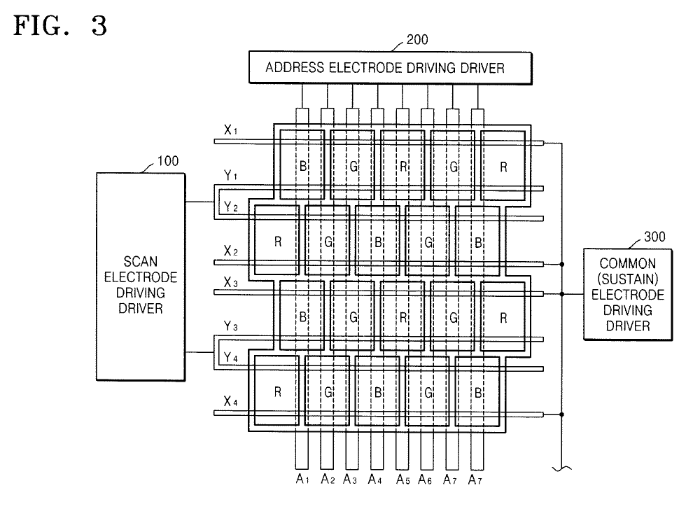

This will be described in more detail with reference to FIG. 3. FIG. 3 is a schematic drawing illustrating a plan view of a plasma display panel for explaining a method of driving the electrodes of the plasma display panel of FIG. 2, according to an embodiment of the present invention. Referring to FIG. 3, the address electrodes A1, A2 . . . A7 are electrically connected to an address electrode driving driver 200 via a terminal unit (not shown) and a suitable signal transfer device (not shown). The Y electrodes are electrically connected to a scan electrode driving driver 100 via the terminal unit (not shown) and the signal transfer device (not shown). The X electrodes are electrically connected to a common electrode driving driver 300 via the terminal unit (not shown) and the signal transfer device (not shown).

However, among the address electrodes adjacent in the first direction, odd numbered address electrodes A1, A3, A5, A7 and so on, are used to select the discharge cells of an odd row, whereas even numbered address electrodes A2, A4, A6, A8 and so on, are used to select the discharge cells of an even row. Therefore, the same scan signals may be applied to the Y electrodes Y1 and Y2 that are disposed in the discharge cells of the even and odd rows and are adjacent in the second direction. Therefore, the Y electrodes Y1 and Y2 are electrically connected to each other and receive the same scan signals from the scan electrode driving driver 100. For example, the conventional ultra high resolution plasma display panel having 4096×1080 pixels, as shown in FIG. 1, needs a total number of 2160 scans to perform one address discharge for all rows of the discharge cells, whereas in the embodiment shown in FIG. 3, the plasma display panel needs a total number of 1080 scans. That is, the number of scan lines is reduced by half from 2160 to 1080.

The X electrodes X1, X2, X3 and X4 for corresponding rows of discharge cells are electrically commonly connected to the common electrode driving driver 300. The same scan signal is applied to the Y electrodes Y1 and Y2, and an address signal is selectively applied to the address electrodes A1 through A7 so that the discharge cells of two adjacent rows can be selected by performing a single scanning operation. Therefore, the number of scan lines to which a scan signal is applied is reduced by half as compared to the number of scan lines of a conventional plasma display panel, and the total time required to perform the scanning operation is reduced by half. Therefore, high resolution and ultra high resolution plasma display panels according the embodiment of the present invention can be provided with sufficient time for scanning the rows of discharge cells when an address discharge occurs in each subfield of an image frame. Furthermore, the number of scan signals applied to the Y electrodes Y1 and Y2 is reduced by half, thereby reducing the size (e.g., reduced by half) of the scan electrode driving driver 100 that includes a scan driving circuit.

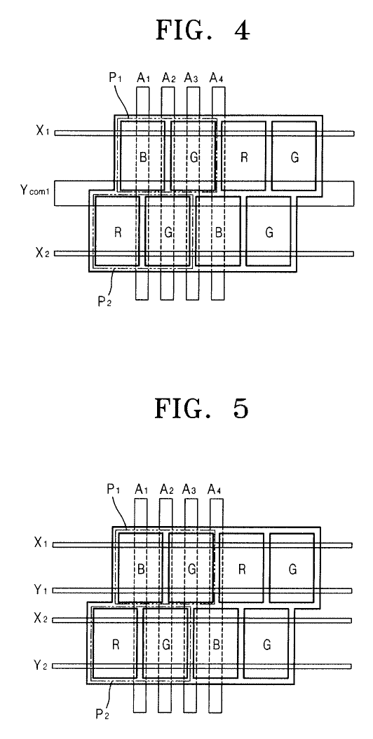

FIG. 4 is a schematic drawing illustrating a plan view of a layout of sustain and address electrodes and discharge cells of a plasma display panel according to another embodiment of the present invention. The layout of the address electrodes and discharge cells of the embodiment of FIG. 4 is the same as that shown in FIG. 2. However, unlike the embodiment shown in FIG. 2, a Y electrode Ycom1 extending in a first direction, which is a common electrode, commonly corresponds to discharge cells of two adjacent rows in a second direction. Therefore, a scan voltage that is applied to the Y electrode Ycom1 is commonly applied to discharge cells of first and second rows. The Y electrode Ycom1 corresponds to the discharge cells of two adjacent rows, thereby reducing the number of Y electrodes by half, such that the width of the Y electrodes may be increased. Also, each of the address electrodes A1, A2, A3 and A4 is disposed to correspond to discharge cells of every two rows.

Furthermore, the address electrodes are electrically connected to an address electrode driving driver, Y electrodes (e.g., Ycom1) are electrically connected to a scan electrode driving driver, and the X electrodes (e.g., X1 and X2) are electrically connected to a common electrode driving driver. A scan signal is applied to the Y electrodes, and an address signal is selectively applied to the address electrodes, so that the discharge cells of two adjacent rows can be selected by performing a single scanning operation. Therefore, the number of scan lines to which a scan signal is applied is reduced by half as compared to that of the conventional plasma display panel, and the total time required to perform the scanning operation is reduced by half. Therefore, high resolution and ultra high resolution plasma display panels according to the embodiment shown in FIG. 4 can be provided with sufficient time for scanning all the discharge cells when an address discharge occurs in each subfield of an image frame. Furthermore, the number of scan signals applied to the Y electrodes is reduced by half, thereby reducing the size (e.g., reduced by half) of the scan electrode driving driver that includes a scan driving circuit.

FIG. 5 is a schematic drawing illustrating a plan view of a layout of sustain and address electrodes and discharge cells of a plasma display panel according to another embodiment of the present invention. The layout of the address electrodes A1, A2, A3 and A4 and discharge cells is the same as that shown in FIG. 2. However, unlike the embodiment shown in FIG. 2, the sustain electrodes are disposed in the order of X1, Y1, X2, Y2, X3, Y3, X4, Y4 and so on. As described with reference to FIG. 3, the Y electrode Y2 adjacent to the Y electrode Y1 are electrically connected to each other so that the same scan signal is applied to the Y electrodes Y1 and Y2. Furthermore, the address electrodes are electrically connected to an address electrode driving driver, the Y electrodes are electrically connected to a scan electrode driving driver, and the X electrodes are electrically connected to a common electrode driving driver. A scan signal is applied to the Y electrodes, and an address signal is selectively applied to the address electrodes, so that the discharge cells of two adjacent rows can be selected by performing a single scanning operation.

Since the same scan signal is applied to the Y electrodes Y1 and Y2 of two adjacent rows of the discharge cells, the number of scan lines to which a scan signal is applied is reduced by half as compared to that of the conventional plasma display panel, and the total time required for performing the scanning operation is reduced by half. As such, high resolution and ultra high resolution plasma display panels according to the embodiment shown in FIG. 5 can be provided with sufficient time for scanning the discharge cells of each row when an address discharge occurs in each subfield of an image frame. Furthermore, the number of scan signals applied to the Y electrodes is reduced by half, thereby reducing the size (e.g., reduced by half) of the scan electrode driving driver that includes a scan driving circuit.

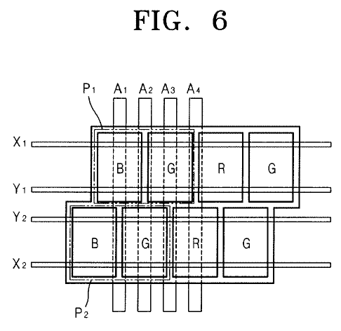

FIG. 6 is a schematic drawing illustrating a plan view of a layout of sustain and address electrodes and discharge cells of a plasma display panel according to another embodiment of the present invention. The layout of the sustain and address electrodes of the embodiment of FIG. 6 is the same as that shown in FIG. 2. However, in the embodiment described with reference to FIG. 2, the discharge cells of an upper row are disposed in the order of B, G, R, G, B, G and so on, and the discharge cells of a lower row adjacent to the upper row are disposed in the order of R, G, B, G, R, G and so on, whereas, in the embodiment of FIG. 6, the discharge cells of an upper row are disposed in the order of B, G, R, G, B, G and so on, and the discharge cells of a lower row adjacent to the upper row are disposed in the order of B, G, R, G, B, G and so on.

The effect of the embodiment of FIG. 6 is similar to those of the embodiments described in reference to FIGS. 2 and 3. In more detail, the number of scan lines to which a scan signal is applied is reduced by half as compared to that of the conventional scan lines, and the total time required to perform the scanning operation is reduced by half. High resolution and ultra high resolution plasma display panels according to the embodiment of FIG. 6 can be provided with sufficient time for scanning the discharge cells of each row when an address discharge occurs in each subfield of each image frame. Furthermore, the number of scan signals applied to the Y electrodes is reduced by half, thereby reducing (e.g., reduced by half) the size of the scan electrode driving driver including a scan driving circuit.

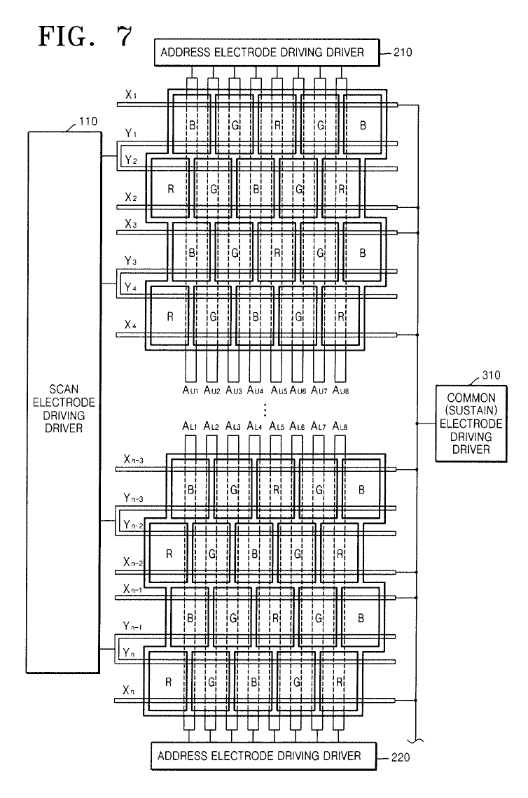

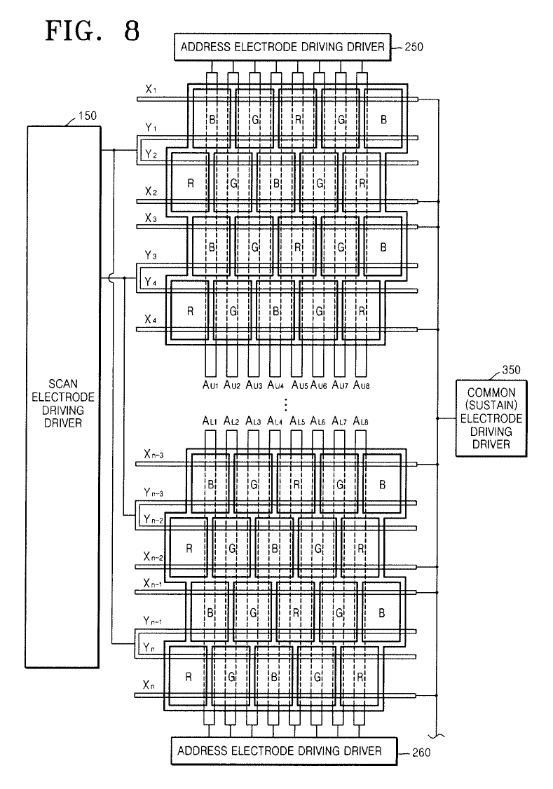

FIG. 7 is a schematic drawing illustrating a plan view of a plasma display panel for explaining a method of driving electrodes of the plasma display panel according to another embodiment of the present invention. The layout of discharge cells and sustain electrodes X1, X2, X3, X4 through Xn-3, Xn-2, Xn-1 and Xn, and Y1, Y2, Y3, Y4 through Yn-3, Yn-2, Yn-1 and Yn is the same as that of the discharge cells and the sustain electrodes X1 and X2, and Y1 and Y2 shown in FIG. 2. However, unlike the embodiment shown in FIG. 2, the plasma display panel shown in FIG. 7 uses a dual scan method. That is, address electrodes Au1, Au2 through Au7 and Au8 are upper address electrodes, and AL1, AL2 through AL7 and AL8 are lower address electrodes. Both the upper and lower address electrodes extend in a second direction. Two address electrode driving drivers 210 and 220 for applying address signals to the upper and lower address electrodes are disposed to correspond to the upper and lower address electrodes.

The dual scan method applies all address signals to the upper and lower address electrodes Au1, Au2, through to Au7 and Au8, and AL1, AL2, through to AL7 and AL8 during an address discharge, thereby halving the time required to perform the address discharge. Also, like the previous embodiments, the number of scan lines to which a scan signal is applied is reduced by half as compared to that of the conventional scan lines, and the total time required to perform the scanning operation is reduced by half. High resolution and ultra high resolution plasma display panels according to the embodiment of FIG. 7 can be provided with sufficient time for scanning the discharge cells of each row when an address discharge occurs in each subfield of each image frame.

FIG. 8 is a schematic drawing illustrating a plan view of a plasma display panel for explaining a method of driving electrodes of the plasma display panel according to another embodiment of the present invention. Referring to FIG. 8, a scan signal, which is the same as a scan signal that is commonly applied to Y electrodes Y1 and Y2, is applied to Y electrodes Yn and Yn-1. A scan signal, which is the same as a scan signal that is commonly applied to Y electrodes Y3 and Y4, is applied to Y electrodes Yn-2 and Yn-3. For example, the conventional ultra high resolution plasma display panel having 4096×1080 pixels shown in FIG. 1 needs 2160 scans to generate an address discharge in all the discharge cells once, whereas in the embodiment of FIG. 8, the plasma display panel needs a total number of 540 scans. That is, the number of scan lines is reduced by ¼ from 2160 to 540. Therefore, the total time required to perform the scanning operation is reduced by ¼. High resolution and ultra high resolution plasma display panels according to the embodiment of FIG. 8 can be provided with sufficient time for scanning the discharge cells of each row to generate an address discharge in each subfield of each image frame.

While the present invention has been particularly shown and described with reference to some exemplary embodiments thereof, it will be understood by those of ordinary skill in the art that various changes in form and details may be made therein without departing from the spirit and scope of the present invention as defined by the following claims, and their equivalents.

What is claimed is:

1. A plasma display panel comprising:
a first substrate and a second substrate facing the first substrate;
barrier ribs between the first substrate and the second substrate for partitioning a space between the first substrate and the second substrate into red (R) discharge cells, green (G) discharge cells, and blue (B) discharge cells;
a plurality of sustain electrodes extending in a first direction between the first substrate and the second substrate; and
a plurality of address electrodes extending in a second direction between the first substrate and the second substrate, the plurality of address electrodes crossing the plurality of sustain electrodes,
wherein a G discharge cell of the G discharge cells forms a pixel with an adjacent one of the B discharge cells or an adjacent one of the R discharge cells in the first direction, and
wherein the G discharge cell and an adjacent one of the G discharge cells in the second direction are offset from each other in the first direction by ½ of a discharge cell pitch of the plasma display panel.

2. The plasma display panel of claim 1, wherein a ratio of the total number of the R discharge cells, the G discharge cells and the B discharge cells of a display area of the plasma display panel is approximately 1:2:1.

3. The plasma display panel of claim 1, wherein each of the R discharge cells, the G discharge cells and the B discharge cells defined the barrier ribs has a substantially rectangular shape.

4. The plasma display panel of claim 1, wherein the plurality of sustain electrodes comprise X electrodes and Y electrodes that are parallel to each other in each of the R discharge cells, the G discharge cells and the B discharge cells.

5. The plasma display panel of claim 4, wherein the X electrodes and the Y electrodes are arranged in an order of X1, Y1, Y2, X2, X3, Y3, Y4, X4 through Xn-3, Yn-3, Yn-2, Xn-2, Xn-1, Yn-1 and Yn, Xn in the second direction.

6. The plasma display panel of claim 4, wherein the X electrodes and the Y electrodes are arranged in an order of X1, Y1, X2, Y2, X3, Y3, X4, Y4 through Xn-3, Yn-3, Xn-2, Yn-2, Xn-1, Yn-1 and Xn, Yn in the second direction.

7. The plasma display panel of claim 5,
wherein two of the Y electrodes corresponding to two adjacent discharge cells, respectively, in the second direction among the R discharge cells, the G discharge cells and the B discharge cells are electrically coupled to each other, and
the two of the Y electrodes are configured to be concurrently applied with a scan signal.

8. The plasma display panel of claim 6, wherein two of the Y electrodes corresponding to two adjacent discharge cells of the R discharge cells, the G discharge cells and the B discharge cells in the second direction are configured to be concurrently applied with a scan signal.

9. The plasma display panel of claim 1,
wherein the plurality of sustain electrodes comprise X electrodes, each of the X electrodes corresponding to a row of the R discharge cells, the G discharge cells and the B discharge cells, the row extending in the first direction, and
wherein the plurality of sustain electrodes comprise Y electrodes, each of the Y electrodes corresponding to two adjacent rows of the R discharge cells, the G discharge cells and the B discharge cells, the two adjacent rows extending in the first direction.

10. The plasma display panel of claim 1,
wherein a row of first discharge cells of the R discharge cells, the G discharge cells and the B discharge cells extending in the first direction has the first discharge cells arranged in an order of B, G, R and G, and
an adjacent row of second discharge cells of the R discharge cells, the G discharge cells and the B discharge cells has the second discharge cells arranged in an order of R, G, B, G.

11. The plasma display panel of claim 1,
wherein a row of first discharge cells of the R discharge cells, the G discharge cells and the B discharge cells extending in the first direction has the first discharge cells arranged in an order of B, G, R and G, and
an adjacent row of second discharge cells of the R discharge cells, the G discharge cells and the B discharge cells has the second discharge cells arranged in an order of B, G, R and G.

12. The plasma display panel of claim 1,
wherein the plurality of address electrodes comprise upper address electrodes and lower address electrodes, and
an address signal is applied to the upper address electrodes and the lower address electrodes by an upper address electrode driving driver and a lower address electrode driving driver, respectively.

13. The plasma display panel of claim 4,
wherein the Y electrodes comprise upper Y electrodes and lower Y electrodes, and
one of the upper Y electrodes and a corresponding one of the lower Y electrodes are electrically coupled together, and are applied with a same scan signal.

14. A plasma display device comprising:
a first substrate and a second substrate facing the first substrate;
scan electrodes and sustain electrodes extending in a first direction between the first substrate and the second substrate;
address electrodes extending in a second direction between the first substrate and the second substrate, the address electrodes crossing the sustain electrodes and the scan electrodes;
barrier ribs between the first substrate and the second substrate and defining red (R) discharge cells, green (G) discharge cells and blue (B) discharge cells at crossing regions of the scan electrodes, the sustain electrodes and the address electrodes;
an address electrode driving driver for driving the address electrodes;
a scan electrode driving driver for driving the scan electrodes; and
a sustain electrode driver for driving the sustain electrodes, wherein a G discharge cell of the G discharge cells forms a pixel with an adjacent one of the B discharge cells or an adjacent one of the R discharge cells in the first direction, and
wherein the G discharge cell and an adjacent one of the G discharge cells in the second direction are offset from each other in the first direction by ½ of a discharge cell pitch of the plasma display device.

15. The plasma display device of claim 14, wherein two of the scan electrodes extending in the first direction and corresponding to two adjacent discharge cells in the second direction, respectively, among the R discharge cells, the G discharge cells and the B discharge cells are configured to be concurrently applied with a same scan signal.

16. The plasma display device of claim 14,
wherein each of the sustain electrodes corresponds to a row of the R discharge cells, the G discharge cells and the B discharge cells, the row extending the in the first direction, and
each of the scan electrodes corresponds to two adjacent rows of the R discharge cells, the G discharge cells and the B discharge cells, the two adjacent rows extending in the first direction.

17. The plasma display device of claim 14,
wherein a row of first discharge cells of the R discharge cells, the G discharge cells and the B discharge cells has the first discharge cells arranged in an order of B, G, R and G, the row extending in the first direction, and
an adjacent row of second discharge cells of the R discharge cells, the G discharge cells and the B discharge cells has the second discharge cells arranged in an order of R, G, B and G, the adjacent row extending in the first direction.

18. The plasma display device of claim 14,
wherein a row of first discharge cells of the R discharge cells, the G discharge cells and the B discharge cells has the first discharge cells arranged in an order of B, G, R and G, the row extending in the first direction, and
an adjacent row of second discharge cells of the R discharge cells, the G discharge cells and the B discharge cells has the second discharge cells arranged in an order of B, G, R and G, the adjacent row extending in the first direction.

19. The plasma display device of claim 14,
wherein the address electrodes comprise upper address electrodes and lower address electrodes,
the upper address electrodes are configured to be addressed by the address electrode driving driver or a second address electrode driving driver, and
the lower address electrodes are configured to be addressed by the other one of the address electrode driving driver and the second address electrode driving driver.
